(19) United States
(12) Patent Application Publication
(10) Pub. No.: US 2013/0323386 A1
(43) Pub. Date: Dec. 5, 2013

(54) AUTOMATED CIRCULATING RESERVOIR THAW DEVICE

(71) Applicants: Andrew Luketic, Huntington Beach, CA (US); Ryan Hofman, Redondo Beach, CA (US); Christine Souza, Huntington Beach, CA (US)

(72) Inventors: Andrew Luketic, Huntington Beach, CA (US); Ryan Hofman, Redondo Beach, CA (US); Christine Souza, Huntington Beach, CA (US)

(21) Appl. No.: 13/629,580

(22) Filed: Sep. 27, 2012

Related U.S. Application Data
(60) Provisional application No. 61/689,198, filed on Jun. 1, 2012.

(51) Int. Cl. A23L 3/365

(52) U.S. Cl. 426/524; 99/483

(57) ABSTRACT

An automated circulating reservoir thaw device may be provided either as a clean stainless steel companion of comparable size to other kitchen food preparation structures, or as a “drop in” unit which could be installed into existing work spaces in the kitchen environment. The automated circulating reservoir thaw device includes a holding tank and a pump to recirculatingly deliver of one quarter gallon per minute to 3 gallons per minute for a nominal 35 gallon capacity, and controls for actuating a single cold water tap for an automatic fill, and the recirculating pump to facilitate thawing of frozen food items.

This is a continuing application of provisional patent application No. 61/689,198 filed Jun. 1, 2012.

### FIELD OF THE INVENTION

The present invention relates to improvements in the field of food precessing equipment for properly and rapidly defrosting frozen food while avoiding high heat and without significant heat input as a safe, effective, low cost automated circulating reservoir thaw device and method for thawing food which will enhance the consistency and flavor of the thawed food while reducing the time before cooking to a minimum safe time based upon passive heat absorption with moving water as a thermal conductive medium. The invention is especially effective and efficient in the restaurant setting where a shorter term advance thaw translates into less premature thawing and less spoilage.

### BACKGROUND OF THE INVENTION

It is well known that frozen food which is directly cooked, especially flame cooked will likely ruin the consistency, flavor, and edibility of such frozen cooked food. This is especially true for meats which may come frozen in a significant mass size. Nearly any step taken to have a rapid thaw can result in unwanted effects. Direct boiling can waste exterior seasonings and vitiate the texture with water, and ruin the ability to cook directly later.

Subdividing the food mass while frozen brings another set of unwanted results. A change in shape of the dish can ruin the intended method of cooking or presentation. Cutting a frozen mass of food can physically spoil the food. As an example, a meat mass cut while frozen will produce bone and meat fragments which contaminate the desired dish or require meticulous inspection and fine removal of unwanted fragments.

Two methods most often used in a restaurant kitchen is the continuous running of water over a mass of frozen material which utilizes takes 5-10 gallons of water per minute, but which results in waste of water as a community resource even where the restaurant is charged for the water it uses. In the worst case, this “waterfall” approach can involve piling hundreds of pounds of meat into a three compartment sink, turning on the cold water tap full blast and walk away for four or five hours. Aside from the energy and water waste, multiple problems arise with this system. First, the product on top is getting all of the impact and benefit of the water. If the temperature is not moderated correctly, the outside of the meat may be heating up while the inside stays frozen. Immediately, food safety is at risk. Even if the food product on top only gets defrosted on its top side, its underside may be untouched by the running water. At the same time, the lower levels of meat may only have water touching their bottom sides. The presence of an employee is at hand for those hours to move the product around for even thaw coverage will likely fail. Secondly, the longer that frozen product is uncovered in a restaurant kitchen, the more likely contaminants can enter the food, including insects, cleaning solutions, employees dirty hands, dirty dishes being passed over the top, and more.

An other method has simply been to place the food in ambient air and to wait for defrost to occur. Because air is such a poor conductor of heat, the defrost takes a significant amount of time. Air defrost can be augmented by blowing air, but unless the air and the fan is completely clean, the fan may end up blowing collected airborne dust directly onto the food.

The main method for defrosting includes either exposing the food to a room temperature atmosphere or exposing the food to a refrigerated atmosphere. Both require significant time allowed for defrost, and are not very predictable. Inability to predict thaw time is due to uncertain air flow patterns in a room or in a refrigerator environment, coupled with the mass and area of the food items. Further complicating factors are the packaging, whether the packaging is removed (or can be removed) or not, and the size and surface area of the frozen food item. A frozen food item which is only a half inch thick, even if massive, will thaw much more rapidity than a massive round item, such as a frozen ham.

Where some foods may be unwrapped or where some foods are provided in an unwrapped state, it is important to isolate the exposed food from contamination and insure that it is thawed in a safe, clean, controlled environment. This is especially the case in a regulated restaurant setting where the protection of the consuming public is of key importance. State and local food handling rules dictate the amount of time food can be left out, the amount of time it can be above or below certain temperatures.

A major cost effect in a restaurant setting is the amount of food which is thawed in anticipation of its cooking and preparation at a significantly later time. Underestimating the volume of food to be thawed places the food preparer in a position to either reporting the item as unpreparable within a normal wait time and thus “out” or taking a risk of cooking the frozen food beginning with a frozen state and risking rejection by the restaurant patron. On the other hand, if a preparer thaws too much food in advance, the food may typically be forced to be fully cooked and prepared, which will contribute to food waste. In the alternative, it may be possible to serve the pre-cooked food later on, but it will not be fresh and the food preparer will again risking rejection by the restaurant patron.

There is currently no conventionally available method or device which can relieve restaurant managers of the burden of initiating a lengthy defrost cycle that can and will often result in spoiled food, lowered food safety or simply having to report “out” of an item that the restaurant has in frozen form. For example, it takes at least 2 days to defrost 10 pounds of frozen chicken, and once that chicken leaves the freezer, the food safety clock starts ticking. If the restaurant tries to stretch the time the food is viable to avoid throwing it out, the customers may become sick by consuming the spoiled meat.

Therefore, what is needed is a more automated, more safe and less costly device and method for defrosting frozen food items. Inexpensive cost should include the cost of equipment, cost of maintenance and cost of operation. The needed solution to this problem in a restaurant kitchen environment should eliminate unwanted negative variances in food quality associated with quick thaw attempts and should facilitate the proper saving of food in the process from thawing to final preparation.

### SUMMARY OF THE INVENTION

An automated circulating reservoir thaw device may be provided either as a clean stainless steel companion of comparable size to other kitchen food preparation structures, or as a “drop in” unit which could be installed into existing work spaces in the kitchen environment. The automated circulating reservoir thaw device includes a holding tank preferably constructed of a thermally conductive, non-corrosive material, preferably stainless steel. 16 gauge 304 #4 stainless steel sheet has been found to work well in this application. The tank may preferably be located at a counter top level so that food workers can easily load, unload, operate and observe the automated circulating reservoir thaw device without extra effort.

The holding tank of the automated circulating reservoir thaw device used in an average restaurant may have dimensions which include a depth of about seventeen inches, a width of about two feet, and a front to back depth of about twenty inches, or a capacity of about 35 gallons. Any size is possible, but practical limits may include an upper limit in which the location, loading and unloading of the tank may begin to become onerous for workers to load and unload. A practical lower limit may include a size sufficient to thaw a single unit of food. The size cited above is one which may be able to defrost three cases of frozen ribs, equaling 250 pounds of frozen food product.

The automated circulating reservoir thaw device tank will preferably include at least one, and preferably a pair of oppositely oriented and nearly maximally offset water discharge ports, and it has been found that in the 35 gallon size that water discharge ports of one half inch in diameter have been shown to work well. The opposite and widely offset discharge ports tend to create a swirling effect in the main automated circulating reservoir thaw device tank. Ideally the force of water exiting the discharge ports is not of great velocity, and a pump capacity to recirculatingly deliver of one quarter gallon per minute to 3 gallons per minute for a nominal 35 gallon automated circulating reservoir thaw device tank should work acceptably.

The automated circulating reservoir thaw device tank has an exit port preferably located near its bottom corner (in the case of a rectangular cubic tank) and oriented to intake water along the same stirring direction to complement the one or two upper discharge ports. A recirculating pump and its controls can be located in a combination cabinet and drainage board structure located adjacent the automated circulating reservoir thaw device tank which may also facilitate an additional work space for either container loading prior to placement of frozen food into the automated circulating reservoir thaw device tank, or a processing station for food preparation as food is taken from the automated circulating reservoir thaw device tank.

In the alternative, the automated circulating reservoir thaw device tank and stand assembly can be provided having a pump and sensor location underneath it, and without any adjacent structure. In this manner the automated circulating reservoir thaw device tank can be utilized with any adjacent working surfaces provided either by existing structures, or by selection of a specialized structure complementary to the automated circulating reservoir thaw device tank facilitates food preparation and thawing and other purposes. The alternative of a “drop-in” automated circulating reservoir thaw device tank is also possible for use with an existing cabinet top and in which a smaller hole may be cut (such as an eighteen inch circular or other shaped hole) and a completely contained automated circulating reservoir thaw device tank installed from the top.

The preferred embodiment of the automated circulating reservoir thaw device tank has an overflow drain located adjacent an upper extent of the holding tank and which may be above or below the recirculating water discharge ports. Also, the automated circulating reservoir thaw device may preferably have a single cold water tap positioned to overlie the holding tank. The single cold water tap may have a flow restriction having a flow rate less than an overflow drain in the main holding tank to eliminate the possibility, under normal usage and non-drainage backup, of overflow.

In the unitary constructed automated circulating reservoir thaw device, the single cold water tap may be controlled by solenoid or other switch to facilitate automatic operation. With a smaller, “drop-in” unit made into a pre-existing table or cabinet, a pre-existing water tap can be utilized or retrofitted with a solenoid control so that the automated circulating reservoir thaw device tank could possibly serve double duty as a thaw structure when controlled as such and as a sink when thawing is not carried on. In the alternative, especially for smaller “drop-in” automated circulating reservoir thaw device tanks, a small line direct connection to the cold water service underneath the cabinet could be accessed, especially with small diameter tubing.

The automated circulating reservoir thaw device tank will preferably have a set of sensors and controller for automatic operation. In a preferred embodiment a level switch can be used by a controller set to shut off any inlet flow it controls once the water level in the holding tank reaches a certain level. Further, a pair of flow inlet solenoids can be used so that the controller can switch between a relatively higher flow during fill up and a relatively much lower flow during what may be known as a dribble pass through operation. In some jurisdictions, health laws require a small one or two percent continuous slip stream of entry fresh water and exit tank water. Where local jurisdictions require this, a “slip stream” mode can utilize a low flow solenoid with flow restriction for input and the overflow drain as an output exit.

Further where a water level sensor is variable, the user can set the depth of thaw water in the holding tank so that only just enough water is utilized to cover the food articles to be thawed. Where slip stream operation is had with a starting with a lower desired water level, one or more covered drains at various levels can be exposed to create a slip stream operation at various levels. Where the automated circulating reservoir thaw device tank is small, it is likely to have a lesser number of variable levels. The use of the device and method of the present invention can save 3,000 gallons of water per day over the technique of using running tap water for defrosting.

### BRIEF DESCRIPTION OF THE DRAWINGS

The invention, its configuration, construction, and operation will be best further described in the following detailed description, taken in conjunction with the accompanying drawings in which:

FIG. 1 is a perspective view of a stand-alone automated circulating reservoir thaw device appliance with a holding tank on its left side and a working surface drain board on its right side;

FIG. 2 is a schematic front elevation view of the automated circulating reservoir thaw device of FIG. 1 and illustrates the placement of various structures and the overall flow and operation;

FIG. 3 is a schematic side elevation view of the automated circulating reservoir thaw device of FIG. 1 and further illustrates the dimensional layout of the automated circulating reservoir thaw device appliance;

FIG. 4 is one embodiment of a very simple electrical schematic which can be employed for simplified operation of the automated circulating reservoir thaw device;

FIG. 5 illustrates a plan view of a possible “Drop-In” version of a tank which can be used in conjunction with variations on components seen in FIGS. 1-4 to form a more custom automated circulating reservoir thaw device into existing cabinet space; and

FIG. 6 illustrates a food submersion cage which can be used in conjunction with the holding tank to insure that any frozen food items that would otherwise float will be held completely within moving thawing water.

### DETAILED DESCRIPTION OF THE PREFERRED EMBODIMENT

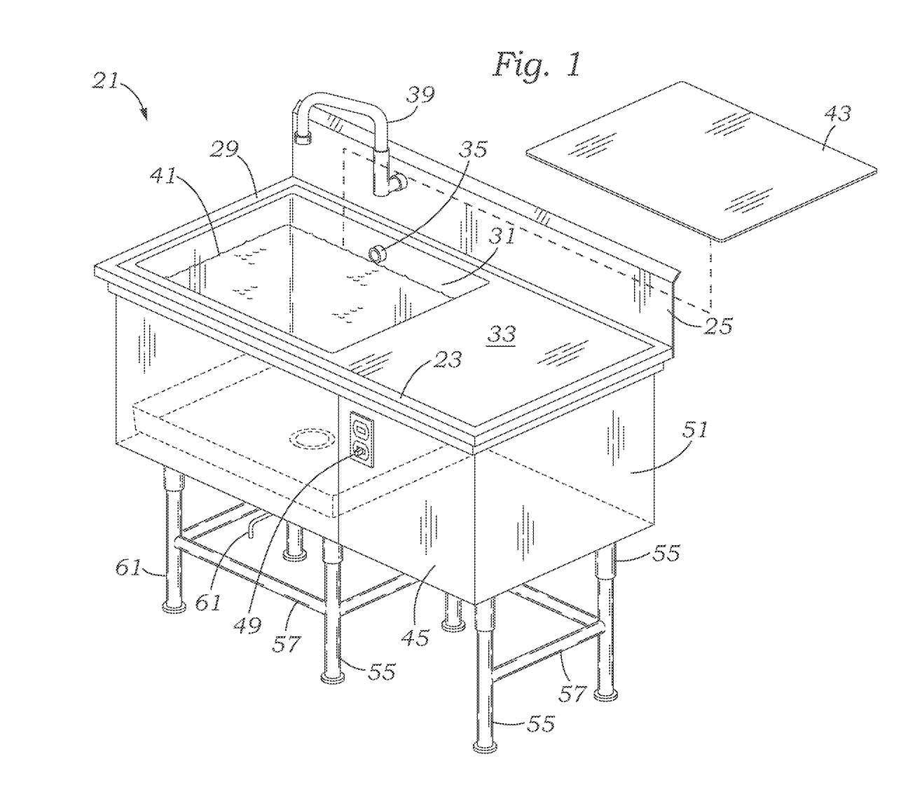

Referring to FIG. 1, a perspective view of a stand-alone embodiment of an automated circulating reservoir thaw device appliance 21 is shown. automated circulating reservoir thaw device appliance 21 has an upper front and side smooth raised edge 23 which blends into a rear splash board 25. Within the perimeter provided by the edge 23 and rear splash board 25, a downwardly recessed level is provided continuous with an internal rim 29 of a holding tank 31, and an upper surface of working structure 33. Working structure 33 may be level or slightly tilted to drain toward the holding tank 31. At the left side of the automated circulating reservoir thaw device appliance 21, the outside of the holding tank 31 can be seen.

At the upper center of the holding tank 31, a drainage structure 35 is seen. A curved tap 39 is seen emerging from the splash board 25 and ending over the holding tank 31. Note that the curved tap is shown without adjustment handles where it is desired to permit automatic operation only. Removal of the ability for non-automatic operation prevent water waste abuses which might be employed by food preparation personnel. A water level 41 is seen just below the train structure 35. An optional lid 43 may be provided which can interfittingly engage the upper open holding tank 31 in a variety of ways. The optional use of a lid would help in isolating the water, especially the water level 41 from debris and it can provide a companion flat working structure roughly even with that of upper surface of working structure 33. Lid 43 may also have structure on the underside, detachable or not, which extends below the water level 41 to help keep floating frozen food items submerged.

At the front of the automated circulating reservoir thaw device appliance 21, and to the right of the holding tank 31, an access panel 45 can be seen. Access panel 45 can be removed to access any number of components behind it and may include pumps, motors, controllers, relays, sensors, wireless status indicator products and annunciators. At the upper left side of the access panel 45, a switch and indicator light set 49 can be seen. The limitation of exterior controls to a simple and indicator light set 49 can be an attractive feature to prevent food preparation personnel from adjusting the operating parameters, especially in a kitchen where the types, sizes, and shapes of frozen food to be thawed will not likely vary. A right side panel 51 enclosing the right side of the automated circulating reservoir thaw device appliance 21 is also seen. Rear and bottom panels are optional and use of same may depend upon internal requirements of the automated circulating reservoir thaw device appliance 21, and need for shelving or stowage as the need arises.

The automated circulating reservoir thaw device appliance 21 having both a holding tank 31 and side working structure 33 is shown as supported by six legs 55, with the leftmost four legs 55 is expected to bear most of the weight of the automated circulating reservoir thaw device appliance 21. Various ones of the legs 55 are connected by horizontal reinforcing bars 57. Lastly, an angled drain valve actuator handle 61 is seen to manually operate a drain (not seen in FIG. 1) to drain the holding tank 31 so that it can be cleaned.

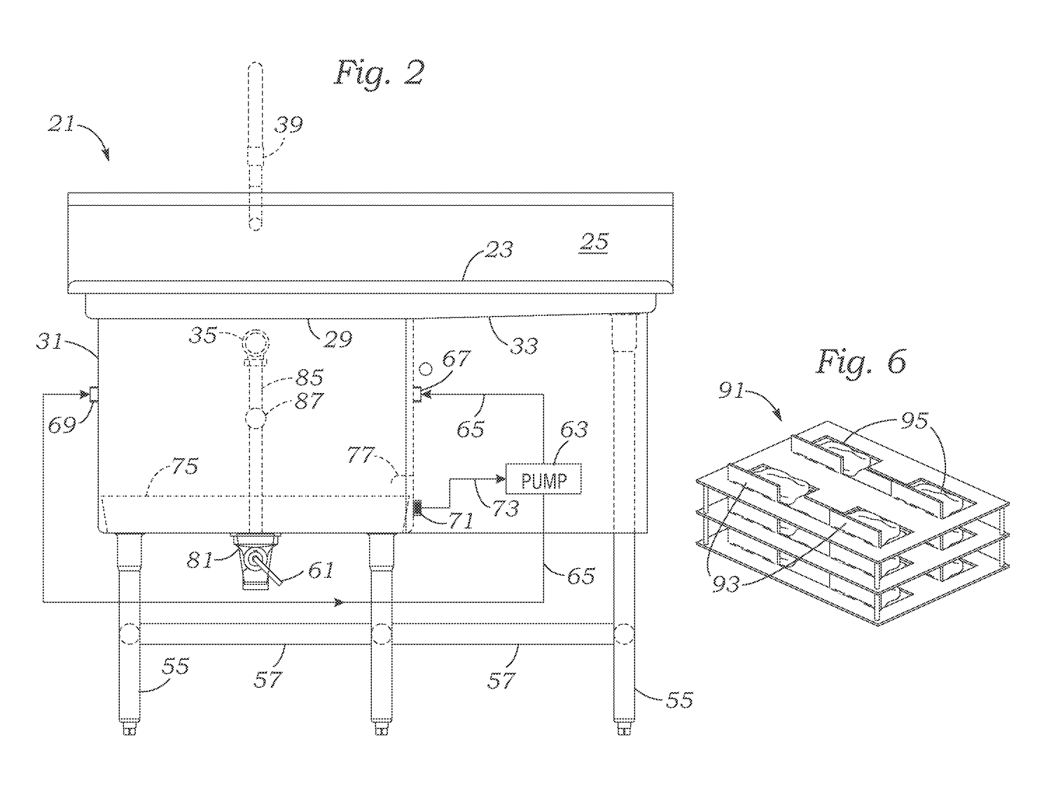

Referring to FIG. 2, a schematic front elevation view of the automated circulating reservoir thaw device appliance 21 of FIG. 1 will illustrate the placement of various structures and the overall flow and operation. In FIG. 2, at the right side, the underside of working structure 33 can be seen has having a slight incline toward the holding tank 31. The right side is seen to contain a pump 63 which may be mounted anywhere, including within or outside of the volume suggested behind access panel 45 or right side panel 51. Further, the type and mounting of pump 63 can be used to reject any wast heat from pump 63 into the adjacent holding tank 31 either through direct metal heat conduction or through jacketing or other heat exchange to pass the slight waste heat from pump 63 into the circulating water stream.

As is shown schematically, the pump 63 output is directed through pump outlet lines 65 to a first tank 31 inlet fitting 67 and a second inlet tank 31 fitting 69 into the holding tank 31. Looking down into the tank 31, a counterclockwise flow of thaw water would be encouraged by placing tank inlet fitting 67 toward the rear of holding tank 31 and away from the observer of FIG. 2 while bringing second tank inlet fitting 69 forward, toward the observer of FIG. 2. A tank exit fitting 71 is seen near the bottom of the holding tank 31 and which should be located forward, toward the observer of FIG. 2 to assist in maintaining the overall counterclockwise flow associated with the aforementioned location of the tank inlet fittings 67 and 69. Tank exit fitting 71 is connected to an inlet of pump 63 via a pump return line 73.

At the left side of FIG. 2, and within the holding tank 31, an inverted “U-shaped” standing angled metal grating 75 is seen schematically. Metal grating 75 may be made of 16 gauge 304 #4 stainless steel perforated sheet with 3/16 hole and stagger to raise any thaw product above any heavier than water sediment that might sink to the bottom of the holding tank 31. As can be seen, a portion of the metal grating 75 has a planar portion facing a planar portion of the holding tank 31 adjacent the fitting 71. This close relationship enables the incorporation of a slip fit filter 77, or the incorporation of a filter 77 within an opening or other structure of metal grating 75. Ideally a filter 77 should be amenable to quick removal, inspection and cleaning.

Any number of support structures can be used in place of inverted “U-shaped” standing angled metal grating 75, including structures which provide higher support, more highly perforated support and even stair stepped support. Specialized supports (not shown) could be used to minimize the swirling velocity of thaw water and in some cases provided as an isolation container sauces, spices and marinades to hold frozen food items which would be damaged by water. During operation, the holding tank 31 may preferably be able to tolerate food additives regardless of whether these additives are deliberately added or whether food additives were packed and frozen with the food items being defrosted.

Also at the left side of FIG. 2, a drain valve 81 operated by angled drain valve actuator handle 61 is seen. During operation, especially where a slip stream overflow cycle is used, any water from the surface 41 which is above the drainage device 35 will travel down a drain pipe 85 and freely through the drain valve 81 and into the drain exit which may preferably be in a normally occurring position below the drain valve 81 and is not shown. Alternative drainage devices 87 and more may be provide where it is desired to operate with a lesser volume of water where it is also sought to maintain slip stream operation. Alternative drainage device openings into the drain pipe 85 could be physically shut off or capped when drainage from that level is not desired.

Where operation of the automated circulating reservoir thaw device appliance 21 is truly automated, a food worker need only insure that the holding tank and the “U-shaped” standing angled metal grating 75 have been cleaned and are ready for service, then check the drain valve 81 to make sure that it is closed (or close the drain valve 81) so that thawing water introduced from the curved tap 39 will cause the holding tank 31 to fill rather than simply allow freshly introduced water to drain to the exit line to which the drain valve 81 is connected. The food worker then loads frozen food items int the holding tank and flips the switch of the switch and indicator light set 49 on so that the holding tank 31 will begin filling. The food worker can then walk away with the indicator light of the switch and indicator light set 49 giving a distance visual indication that the automated circulating reservoir thaw device appliance 21 is in operation.

After the days operation have concluded, the food worker simply removes any thawed or thawing food items left in the holding tank 31 and subjects them an appropriate level of refrigeration to insure their proper preservation. The switch of the switch and indicator light set 49 can be shut off to stop water from circulating withing the holding tank 31. Then, actuation of the angled drain valve actuator handle 61 will cause the holding tank 31 to drain into the buildings waste water exit service. Cleaning of the holding tank 31 can be done independently with another supply of water, or the indicator light of the switch and indicator light set 49 can be turned on (for short periods) to assist in cleaning. It may also be possible to turn the automated circulating reservoir thaw device appliance 21 on after cleaning the holding tank 31 to allow the lines flowing to and from the pump 63 and the pump 63 impellers (not shown) to clean themselves by virtue of infusion of clean water. After such a second cycle, the automated circulating reservoir thaw device appliance 21 can be turned off, drained, and the holding tank 31 wiped clean.

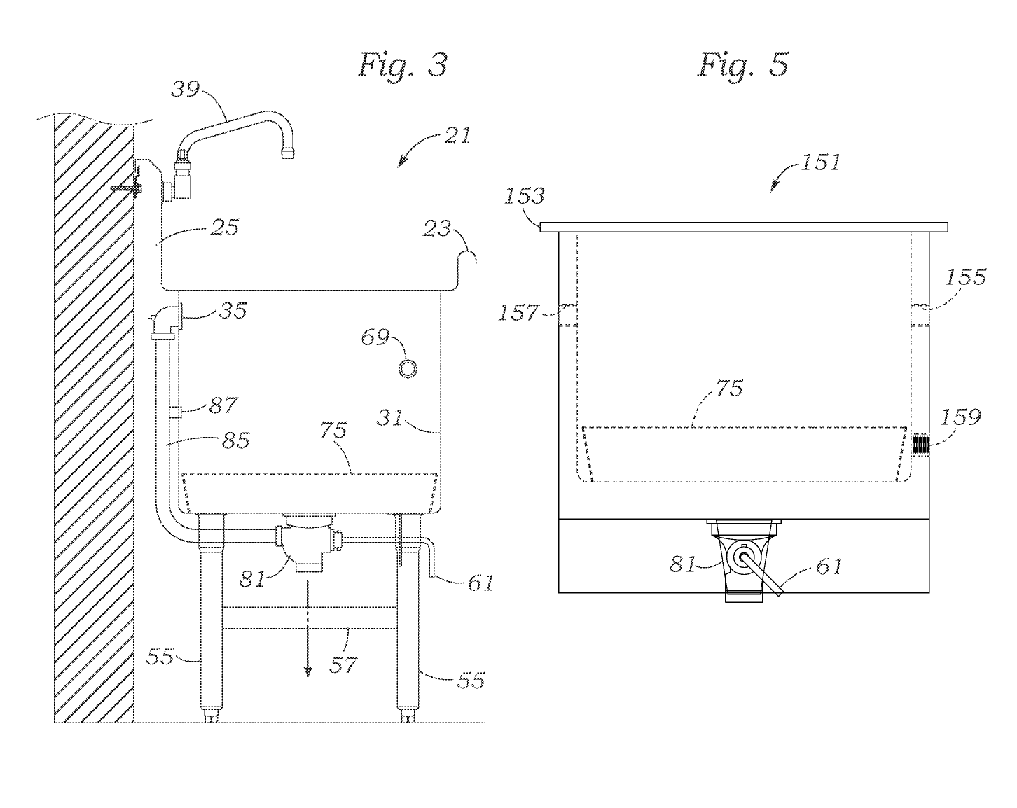

Referring to FIG. 3, a schematic side elevation view of the automated circulating reservoir thaw device 21 of FIG. 1 gives further indications of dimensional layout. The second inlet tank 31 fitting 69 is show relatively forward with respect to holding tank 31 in order to produce the swirling effect mentioned with regard to FIGS. 1 and 2. Also seen is the drain pipe 85 extending from drainage structure 35 to the drain valve 81 which is expected to be an open connection to an exit of drain valve 81 shown by a down arrow from the bottom of drain valve 81 regardless of the position of the angled drain valve actuator handle 61. Angled drain valve actuator handle 61 only opens and closes the exit of the drain valve 81 with respect to the inside of holding tank 31.

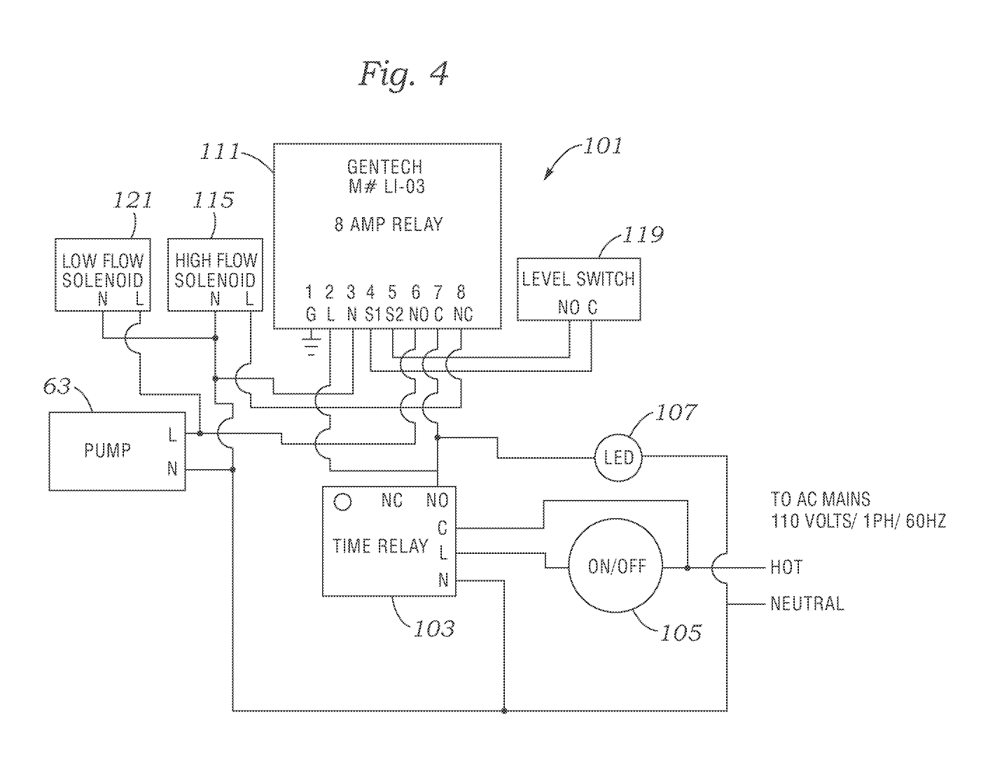

FIG. 4 is one embodiment of a very simple electrical schematic of a circuit 101 which can be employed for simplified operation of the automated circulating reservoir thaw device 21, and includes at the right, a “HOT” and “NEUTRAL” electrical line which may be connected to the AC means of any building. A TIME RELAY block 103 is connected to receive power whenever the circuit 101 is plugged into the AC mains of any building. An ON/OFF switch 105 is connected to an action input of the TIME RELAY block 103 to cause an output line to go “high” and which will power an LED 107 and which will energize positions 2 and 7 of an 8-AMP RELAY block 111.

From the 8-AMP RELAY block 111 a signal will be sent to HIGH FLOW SOLENOID BLOCK 115 to actuate the curved tap 39 to begin filling the holding tank 31. When a LEVEL SWITCH block 119 indicates a full condition (or a condition which meets a preset condition of adequate fullness)a signal is sent to the 8-AMP RELAY block 111 which shuts off the HIGH FLOW SOLENOID BLOCK 115 to stop main open filling flow. In cases where a slip stream of flow is to be maintained, the 8-AMP RELAY block 111 may send a signal to a LOW FLOW SOLENOID block 121 to start a low rate of flow, and a powered line energy signal is sent to PUMP block 63 which was also seen in FIG. 2. The disablement of the LOW FLOW SOLENOID block 121 can be accomplished by a wiring change or an internal panel switch.

FIG. 5 illustrates a plan view of a possible “Drop-In” version as a tank 151 which can be used in conjunction with other components to form an automated circulating reservoir thaw device appliance such as automated circulating reservoir thaw device appliance 21. Illustrated is a holding tank 151 which is configured for a close and supported fit in any sort of counter which can have an aperture or hole formed which will fit the holding tank 151.

Holding tank 151 has a rim overhang 153 which vertically support it using a horizontal surface. To make the holding tank 151 amenable for counter top close fit drop-through, the externally protruding fittings, including fittings 67, 69 and 71 have removed, and the bores 155, 157, and 159 are shown as ready to accept fittings 67, 69 and 71 after holding tank 151 has been installed through an opening in a counter top. Bore 159 is shown as threaded, but any of the bores 155, 157, and 159 may have threaded internal surfaces or inset thread inserts.

Structures previously seen, including angled drain valve actuator handle 61, metal grating 75, and drain valve 81 are visible. Drain valve 81 can be seen as having a drain bore 163, and the material of construction of the holding tank 151 can be the same as was shown for automated circulating reservoir thaw device appliance 21, or a thicker material. With the holding tank 151 as a start, the other components, including switch and indicator light set 49, pump 63, pump exit lines 65, first inlet fitting 67 second inlet fitting 69, tank exit fitting 71 and pump return line 73, and circuit 101 can be added once the holding tank 151 is mounted in place. The pump 63 can still be closely located to the holding tank 151 to help passively reject heat into the holding tank 151. However, the user or installer is free to choose a collection of the operable component parts into a housing which can mount underneath a cabinet in which holding tank 151 is mounted.

Referring to FIG. 6 a thawing food submersion cage 91 having flow fins 93 can be used in conjunction with the holding tank to insure that any frozen food items 95 that would otherwise float will be held completely within moving thawing water. Where frozen food items 95 float on one side, the side exposed above the water surface 41 will not thaw at the same rate as the area of the foot item in contact with the water. Any structure which keeps the frozen food items 95 submerged and aids in multiply channeling the thawing water would be efficient.

While the present invention has been described in terms of a device and system used for thawing frozen foods safely and quickly, and in particular a restaurant grade automated device which saves water and frees employee time and attention for more important and demanding tasks, the techniques employed herein are applicable to a wide range of devices and methods.

Although the invention has been derived with reference to particular illustrative embodiments thereof, many changes and modifications of the invention may become apparent to those skilled in the art without departing from the spirit and scope of the invention. Therefore, included within the patent warranted hereon are all such changes and modifications as may reasonably and properly be included within the scope of this contribution to the art.

What is claimed:

1. An automated circulating reservoir thaw device comprising:
a holding tank having a main drain, at least tank input opening, at least one pump return opening;
a pump having a pump output connected to the at least one tank input opening and a pump input connected to the at least one pump return opening;
a supply water tap positioned to admit a supply of water into the holding tank;
a main holding tank drain valve for draining the holding tank;
a water level sensor associated with the holding tank for determining a level of liquid in the holding tank;
a controller connected to the pump, the water level sensor and the supply water tap for actuating the supply water tap to automatically fill the holding tank to a predetermined level upon sensing level from the water level sensor and controlling the pump to circulate water for purposes of thawing any frozen food present in the main holding tank.

2. The process of operating an automated circulating reservoir thaw device comprising the steps of:
at least one of checking a main holding tank drain valve of a holding tank to insure that it is closed and closing a main holding tank drain valve on an automated circulating reservoir thaw device;
placing frozen food items to be thawed into the holding tank;
actuating a switch to start automatic fill the holding tank to a predetermined level upon sensing level from the water level sensor, control of a pump to circulate water for purposes of thawing any frozen food present in the main holding tank.

3. The process of operating an automated circulating reservoir thaw device as recited in claim 2 and further comprising the steps of:
removing any food items left in the holding tank after operation of the automated circulating reservoir thaw device is desired to be shut down;
actuating a switch to stop the pump of the automated circulating reservoir thaw device circulating water; and
opening a main holding tank drain valve on the automated circulating reservoir thaw device to drain the holding tank.
